(19) United States
(12) Patent Application Publication
(10) Pub. No.: US 2005/0193054 A1
(43) Pub. Date: Sep. 1, 2005

(54) Multi-user social interaction network

(76) Inventors: Eric Duane Wilson, West Sacramento, CA (US); Phillip Henry Gochenour, San Francisco, CA (US); Gilbert Gene Engel JR., Reston, VA (US)

Correspondence Address: ROSENFELD LAW CORPORATION, 2165 FILBERT STREET, SUITE 200, SAN FRANCISCO, CA, 94123, US

(21) Appl. No.: 11/058,718

(22) Filed: Feb. 14, 2005

Related U.S. Application Data
(60) Provisional application No. 60/544,735, filed on Feb. 12, 2004.

(51) Int. Cl. G06F 15/16

(52) U.S. Cl. 709/200

(57) ABSTRACT

A system and method for creating a social interaction network by generating a search request at a client device; transmitting the search request to a server; generating a user interface template specially configured for display on the client device; gathering static assets for the user interface template; gathering dynamic assets responsive to the request; merging the static assets and the dynamic assets into the user interface template; and transmitting the user interface to the client device. The gathering step is involves gathers the dynamic assets based upon user defined, system defined and partner defined matches.

### FIELD OF THE INVENTION

Invention relates generally to computer data and information systems, and more particularly to a computer system for storing, processing, displaying and delivering information to a user, primarily over wireless network, in a multi-user interaction model where the information can be a person, place, thing that may be of explicit or implied interest to a user.

### BACKGROUND OF THE INVENTION

Current wireless infrastructure platforms provide individual components for the display of content and the handling of billing transactions. Also, some wireless infrastructure platforms have individual components to achieve specific functions within the wireless environment, such as image transcoding. Currently available wireless infrastructure components are used only for the delivery of content and not for use of wireless social networking applications. Moreover, these platforms fail to act on the user's behalf to gather and collate data that is of interest to the user.

One example of a current social networking platform is offered by Friendster, Inc. (www.friendster.com), which is an online community that connects people through networks of friends for dating and making new friends. The Friendster platform is the subject of U.S. patent application entitled “System, method and apparatus for connecting users in an online computer system based on their relationships within social networks” having application Ser. No. 462,142 and publication No. 20050021750. Friendster allows users to search among members of the service to find others with common interests, and displays what relationship, if any, another user of the service has to the current user. However, Friendster does not have a wireless component that allows users to access the service through a wireless device such as a cell phone or PDA, nor does it incorporate a social agent component that facilitates the search process.

### SUMMARY OF THE INVENTION

In one aspect of the present invention a platform with social agents offers a number of advantages over current wireless infrastructure platforms.

In another aspect of the present invention, social agents improve the overall functionality of wireless applications by providing users with content and matches that are more finely tuned to their individual requirements—social agents offer personalization of content and services. This is especially critical in the wireless environment, where both interface limitations and user concerns over the cost of data transmission hamper user adoption and utilization of services.

In another aspect of the present invention, social agents extend users beyond a known universe. The nature of the wireless medium currently assumes a user who knows what content and services are available, and goes out to interact with them. This is analogous to the basic functioning of wireless phones, which users utilize to interact with a known group of people. Social agents have the ability to “pull” content, matches, and services to users who might otherwise be unaware of them.

In another aspect of the present invention, social agents to solve the problem of “spamming” for content and marketing distribution to wireless users. Again, because of the user cost for data transmission, the low memory capacity of wireless devices, and the limitations of wireless interfaces, users have been especially resistant to the idea of receiving “pushed” content to their wireless devices. Social agents solve this problem by giving users control over the kind of content they want delivered to their devices, and providing them with further refinement of this content so that there is a very high probability that users will find pushed content to be relevant, useful, and interesting.

In another aspect of the present invention, as third generation wireless networks come online and GPS, and other location enabling technologies becomes widely integrated into wireless devices, social agents add additional functionality to location-based services. Persons traveling with wireless devices that have social-agent enhanced applications and services will be able to access a wide variety of unknown content and services as they enter new areas and locations.

In another aspect of the present invention, as massive multi-user network applications are developed that enable users to interact with wide groups of individuals instead of focusing on peer-to-peer interactions, social agents play a critical role in drawing together diverse groups of individuals.

In sum, certain embodiments present invention include a system and method for creating a social interaction network by generating a search request at a client device; transmitting the search request to a server; generating a user interface template specially configured for display on the client device; gathering static assets for the user interface template; gathering dynamic assets responsive to the request; merging the static assets and the dynamic assets into the user interface template; and transmitting the user interface to the client device. The gathering step is involves gathers the dynamic assets based upon user defined, system defined and partner defined matches.

### BRIEF DESCRIPTION OF THE DRAWINGS

FIG. 1 is a block diagram of the system of the preferred embodiment of the present invention.

FIG. 2 is a block diagram depicting a multi-user interaction in the preferred embodiment of the present invention.

FIG. 3 is a flow chart of the method of the preferred embodiment of the invention.

FIG. 4a is a flow chart of user interface generation depicted in FIG. 3.

FIG. 4b is a flow chart of the initial transcoding depicted in FIG. 3.

FIG. 4c is a flow chart of social agent data matching and final transcoding depicted in FIG. 3.

FIG. 4d is a flow chart of payment and delivery processes depicted in FIG. 3.

FIG. 5 is a combination block diagram and flow chart representing the social agent interactions within the system to discover new content for a user.

### DETAILED DESCRIPTION OF THE PREFERRED EMBODIMENTS

### Overview

The preferred embodiment of the present invention is a social networking system for wireless environments. The system includes a basic platform of components that ensure functionality and a consistent user experience across wireless devices and carriers. Additionally, a billing system is provided for transactions between users, carriers, and service providers. Also, the preferred embodiment includes social agents that enable users to sift through available content and potential matches in an intelligent way that accurately reflects the requirements of the user.

The system provides relational and non-relational patterns between entities through the creation of ad-hoc and mesh networks using the concept of social networking to provide ties. Social agents enable users to sift through available content and potential matches in an intelligent way that accurately reflects the requirements of the user. Additionally, given the wealth of potential content and matches available to users, agents learn from past user behavior in order to “pre-digest” available content and matches and present users with a data pool that is specifically oriented to them.

### System Architecture

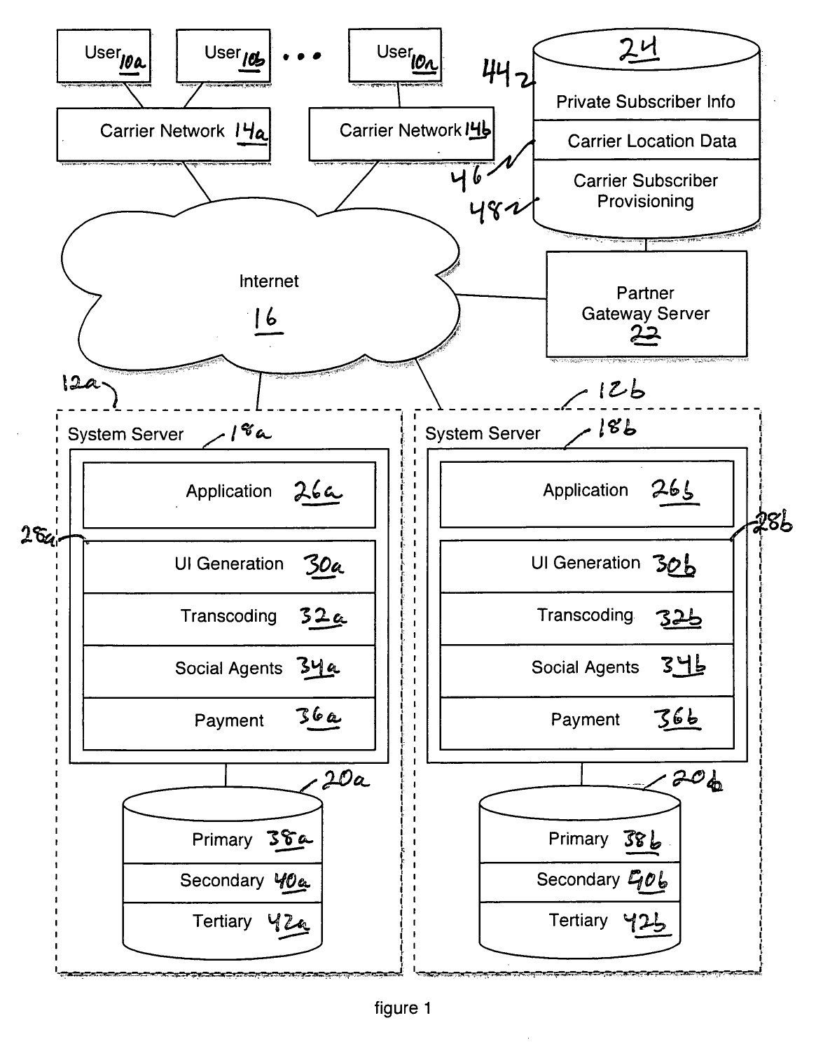

The system of the preferred embodiment in a wireless environment is depicted in FIG. 1. The system includes client devices 10 (each associated with a different user), social network sub-systems 12 (each including a system server 18 and database 20), wireless carrier network 14, Internet 16, system server 18, partner gateway 22, and partner database 24. Client devices 10 are any type of wireless device, such as a cellular phone, cellular enabled PDA, or wireless PDA, which are well known in the art. Wireless carrier network 14 is any type of wireless network, such as a cellular or satellite network, the operation of which is well known in the art. There is a wireless carrier network 14 for each wireless carrier, thus the system may include multiple wireless carriers 14a and 14b.

Each social network sub-system 12 is associated with a specific, dedicated social network application, such as a dating application, music sharing application, gaming application, or the like. Thus, the system may include multiple sub-systems 12, such as a sub-system 12a for a dating application and a sub-system 12b for a game application. Each sub-system 12 includes a system server 18 and a database 20.

System server 18 includes a number of functional components including dedicated application 26 and social/mobile platform 28. Social/mobile platform 28 has several functional elements including user interface (UI) generation 30, image and data transcoding 32, social agents 34, and payment and settlement 36. System server 18 also includes standard structural and functional components necessary for Internet communications, VPN communication, and other standard operations. The functional components are preferably implemented as software operating on one or more CPU's in one or more physical servers. The number of CPU's and physical servers is scaled depending on the number of dedicated applications 26 and the number of client devices 10. Alternatively, dedicated application 26 may be distributed such that it is resident on client device 10. In this alternate embodiment, there is no dedicated application 26 on system server 18.

Sub-system database 20 holds personalized content that has been gathered for a specific user, or that is being gathered, by social agents 34. Sub-system database 20 is associated with system server 18 and includes three logical divisions. Each dedicated application 26, of which there may be many, has its own system database 20. Sub-system database 20 may be implemented in the same physical server as system server 18 or on a number of dedicated RAID devices, depending on the requirements of the system. Primary database 38 stores information relating to dedicated application 26, such as application specific preferences and saved searches. Secondary database 40 stores information collected by social agents 34 from other dedicated applications 26 in the system, such as system generated recommendations, system generated matches, up sell information used by CRM applications based on past user behavior. Tertiary database 42 stores information social agents 26 collect from partner databases 24, such as user location data and advertising information. The information stored in tertiary database 42 allows users with client devices 10 on different carrier networks 14a and 14b to participate in the same application space (i.e., interact within the same dedicated application 26).

System server 18 is in communication with client devices 10 through Internet 16 and carrier network 14. Client devices 10 may be in communication with each other and system server 18 through a variety of different carrier networks 14a and 14b (for example, Verizon, Cingular, and T-Mobile).

System server 18 is also in communication with partner databases 24 through Internet 16 and partner gateway 22 preferably by way of a virtual private network (VPN) or other secure means. Partner databases 24 are databases belonging to partners of the system, such as the wireless carriers, and include a variety of different information including private subscriber information 44, carrier location data 46 and carrier subscriber provisioning information 48. These elements of partner database 24 may implemented in a single physical database or multiple physical databases or any number of configurations known to those skilled in the art.

Private subscriber information 44 belongs to the individual carrier and identifies which carrier is making the request on the behalf of which user, telling social network platform 28 how to communicate with that user. Carrier location data 46 is a direct feed of a specific user's physical location as represented by X-Y coordinates and made available to social agents 34 under rules provided for by each individual carrier. Carrier subscriber provisioning 48 contains data that allows a user to download a specific application which gives the user access to social network platform 28. On Verizon, for example, the user would use their mobile device to download a BREW application from the Verizon Get-It-Now portal and have the system application delivered and installed onto client device 10. In the example of a user downloading an application directly to their handset, sub-system 12 provides the proper provisioning and delivers the correct J2ME binary application to the user based on the make, model, and carrier of their client device 10.

### System Operation

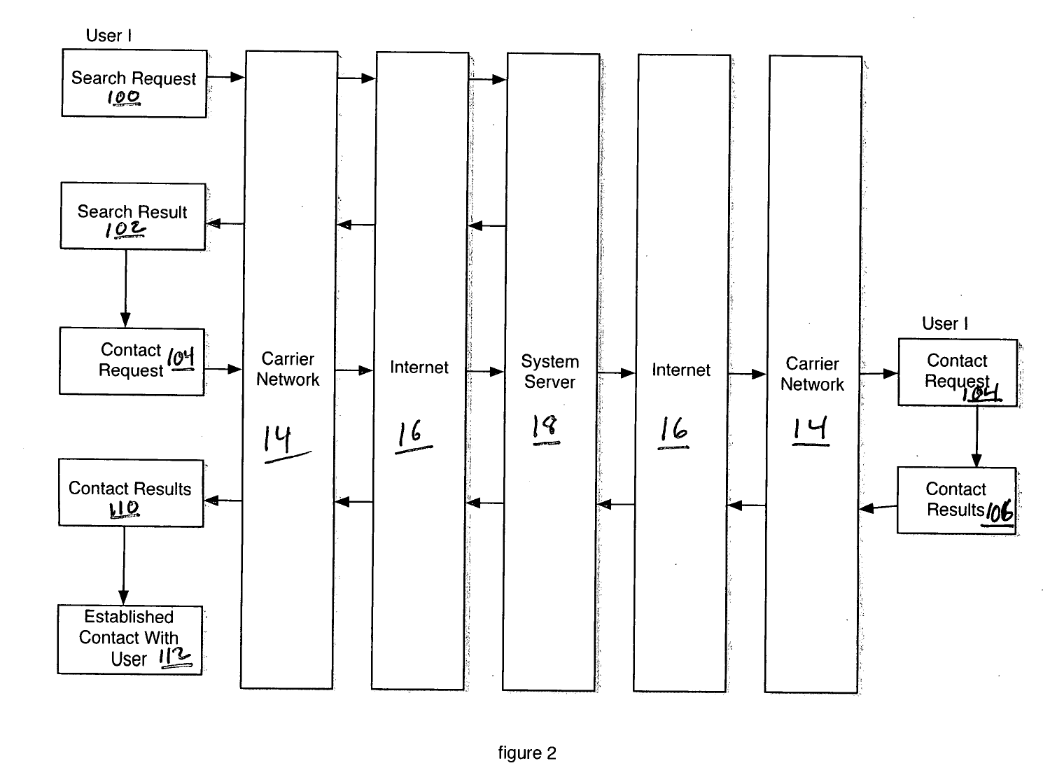

The flow of messages for a multi-user interaction for the preferred embodiment is depicted in FIG. 2. An initiating user with client device 10a initiates a query (such as search request) 100, which is passed through a wireless carrier 14 and then through the Internet 16 to reach the system server 18. The system server 18 processes the query 100 and generates a decision (such as a search result list) 102, which is passed through the Internet 16 and then through the wireless carrier 14 to reach the client device 10a. The first user thereby receives the results 102 of the user initiated query 100. Based on the results 102, the initiating user selects from results 102 to generate a contact request 104 with client device 10a. Contact request 104 is transmitted to carrier network 14, then to Internet 16, and then to system server 18 which processes contact request 104 in order to send contact request 104 to the intended recipient and format contact request 104 for client device 10b. Contact request 104 is then transmitted from system server 18 to carrier network 14 and then to client device 10b of the recipient user. If client device 10a of the initiating user and client device 10b of the recipient user have the same wireless carrier, then contact request 104 is transmitted to and from system server 18 on the same carrier network 14a. However, if client device 10a of the initiating user and client device 10n of the recipient user have different wireless carriers, then contact request 104 is transmitted to system server 18 on carrier network 14a and from system server 18 on carrier network 14b

In response to contact request 104, the recipient user decides whether to accept or reject the contact. Contact results 106, generated by the recipient user with client device 10b, and then transmitted to carrier network 14, then to Internet 16, then to system server 18 for processing and re-formatting, then back to Internet 16, then to carrier network, and finally to client device 10a of the initiating user. If the recipient user accepted the contact, then contact between the initiating user and the recipient user is established in the context of dedicated application 26.

A dating application 26a is an example of an application 26 where multiple users interact, as depicted in FIG. 2, each user creates a profile that contains specific information about that user. Other users can then search for matches based on this profile information. Specifically, the profiling and contact method employed by the system includes the following steps: the first user initiates contact after viewing the second user's profile contained in search results 102; the second user receives a message in contact request 104 that the first user has viewed the profile and is queried as to whether the second user would like to view the profile of the first user; after review the profile if desired, if the answer is no, then the first user receives a message in contact results 110 that the second user is not interested in contact; if the answer is yes, by way of contact results 110, the second user receives the profile of the first user and the second user is queried as to whether the second user would like to make contact with the first user.

### Social/Mobile Platform

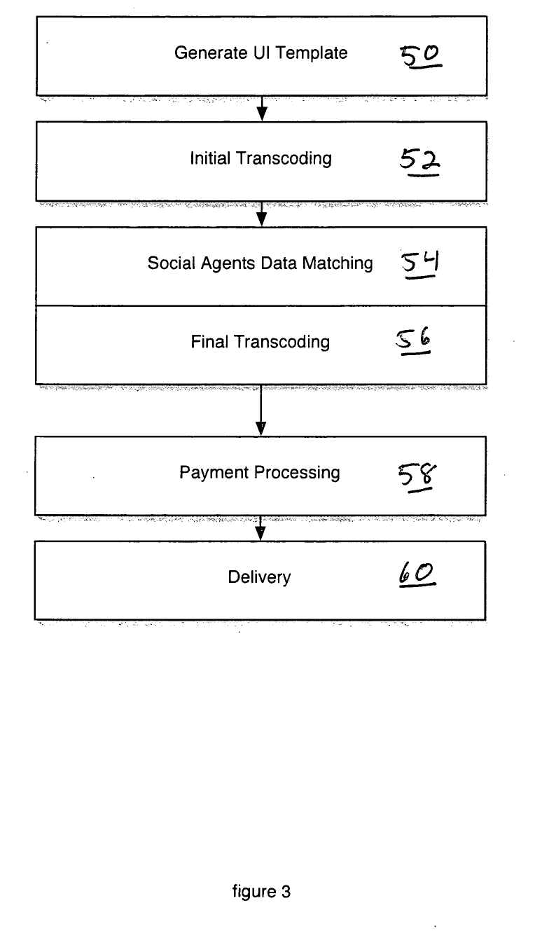

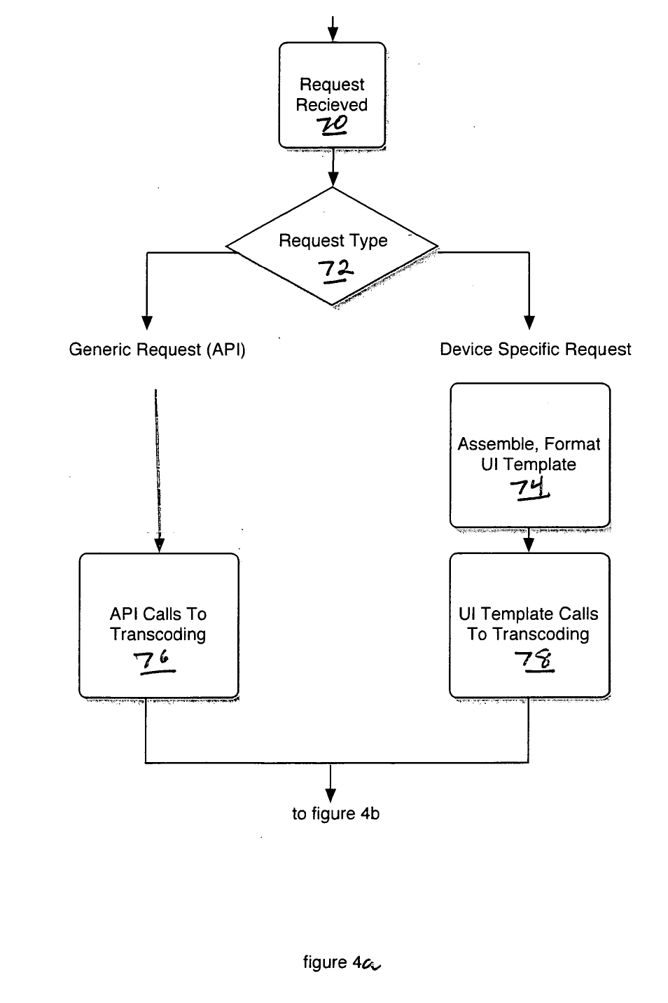

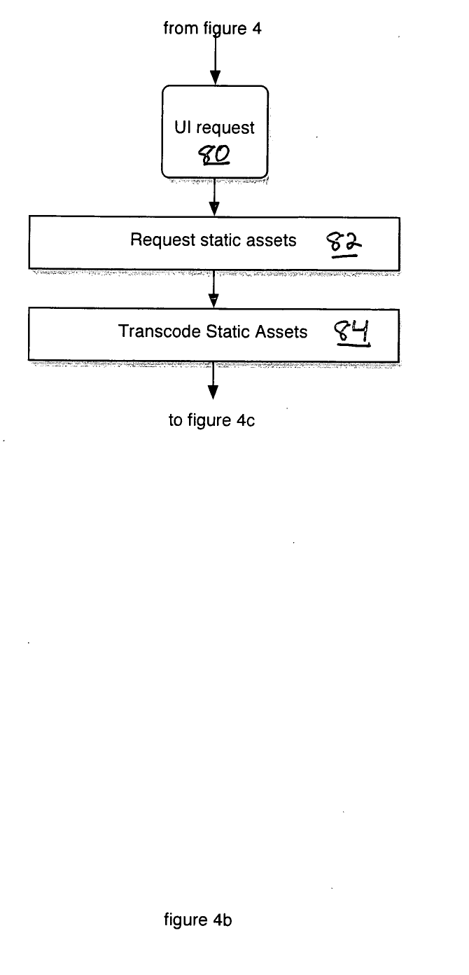

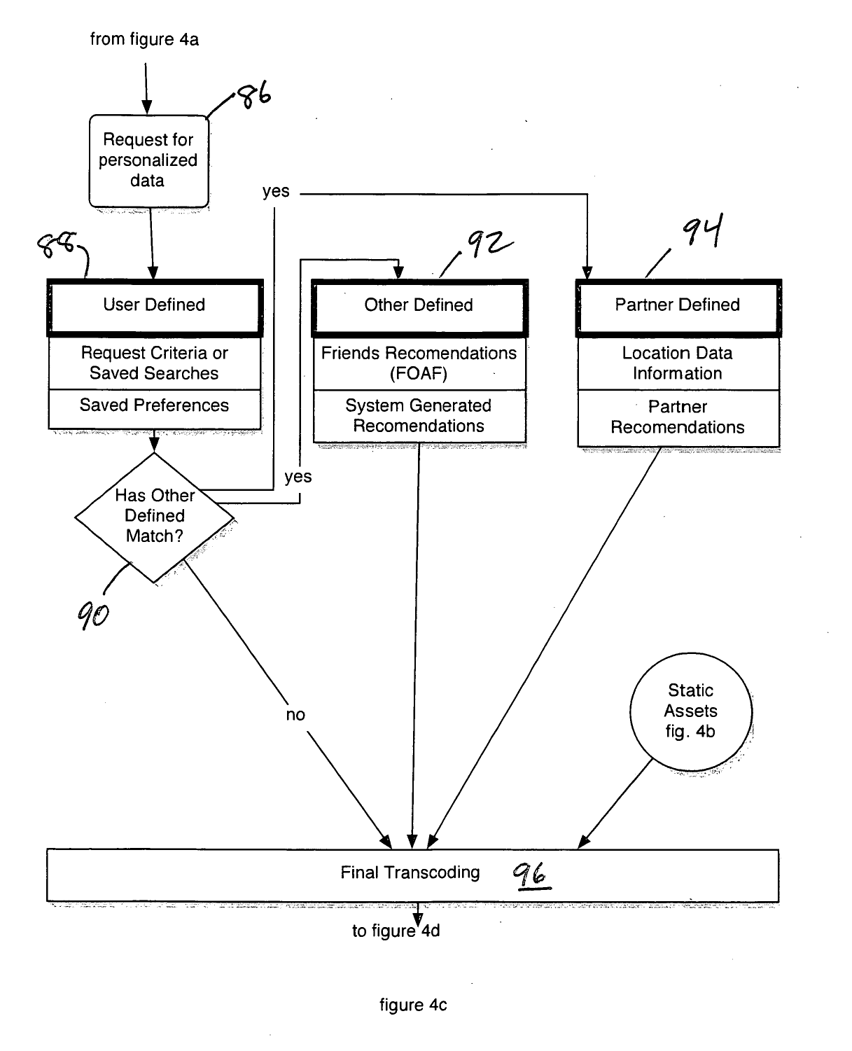

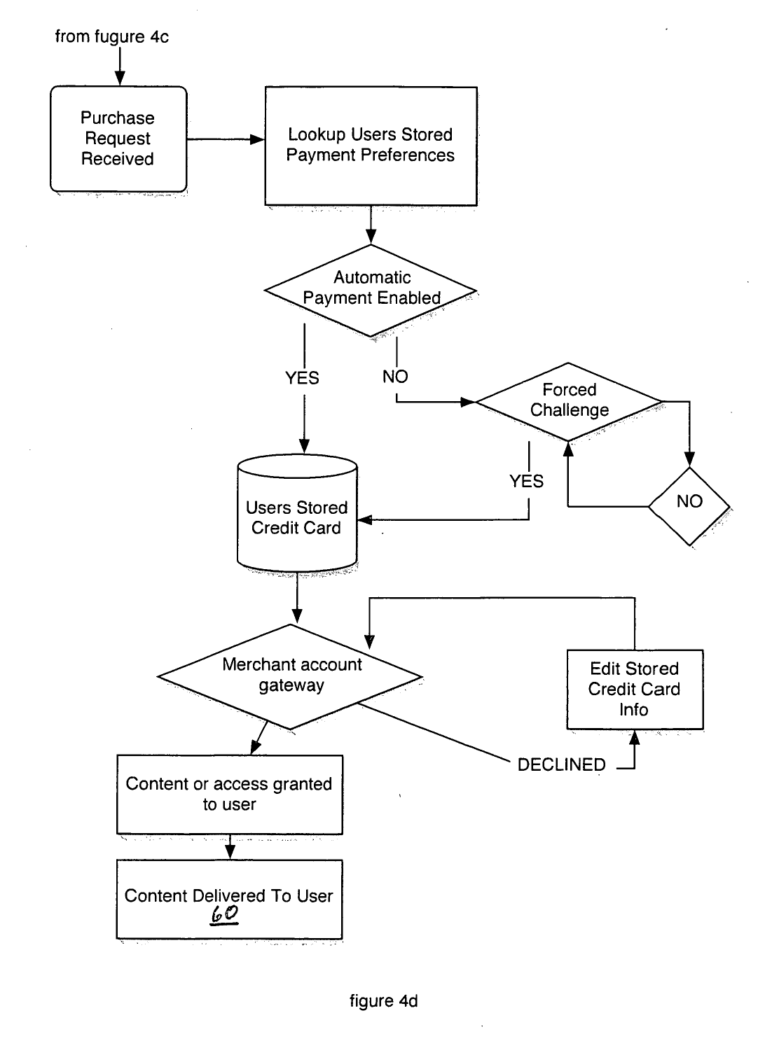

The social/mobile platform 28 of the system is a unique integration of components. The four components of the social/mobile platform 28 for processing user requests 100, the structure of which are depicted in FIG. 1 and the operation of which are depicted in FIGS. 3-4, are as follows:
1) User interface generation engine 42 utilizes a top-down approach to deliver content to any wireless device in the best possible format for that device. This component supports both WAP v1 and WAP v2, xHTML, cHTML, and any HTML version, as depicted in FIG. 4a.
2) Image and content transcoding engine 44 generates device-specific versions of existing content for optimized delivery to various wireless devices. This component provides an image uploader, storage, and thumbnail engine that can generate various image formats based on a template. This component supports GIF and JPG image formats, as well as multi-part email, SMS, and MMS message delivery, as depicted in FIG. 4b.
3) Social agents 34 are proprietary searching and matching agents constructed of Java objects that can learn about user behavior over time and recommend alternative criteria and matches to users, as depicted in FIG. 4c.
4) Payment and account settlement 36, which is a revenue-sharing payment system that allows one-click instant payments by users. Credit card information is stored within the system, or partner, data center and as content is delivered a users pre-defined preferences are read to enable the instant, secure purchase and access to the requested content authorized from a standard merchant account and stored in the users account for access, as depicted in FIG. 4d.

The general operation of the social/mobile platform 28 in response to contact request 100 is depicted in FIG. 3. The operation of each particular component is depicted in FIGS. 4a-d. As shown in FIG. 3, in response to contact request 100, a user interface template formatted particularly for client device 10 is generated (step 50) as depicted in detail in FIG. 4a, then initial transcoding is performed (step 52) as depicted in detail in FIG. 4b and social agent data matching is performed (step 54) as depicted in detail in FIG. 4c, then final transcoding is performed (step 56) as depicted in detail in FIG. 4b, then payment processing is performed if required (step 58) as depicted in FIG. 4d, and then finally the merged UI template and data is transmitted to client device 10 (step 60).

As shown generally in FIG. 3 and in step by step detail in FIGS. 4a-d, a user makes a request 100 for data that resides within the social network platform 28, using their client device 10. Information requests 100 are processed by the user interface generation component 30, the resulting template information is merged with the appropriate images and content (static assets) from the transcoding component 32 and personalized information (dynamic assets) collected by social agents 34 from database 20. Before the compiled information is returned to the user, social agents 34 perform a decision action to compile together personalized content to be included in the reply 102. At this point the resulting data sets are merged into a data package by transcoding component 32 that includes the user's content, personalized information, images formatted to fit client device 10, and an interface designed to work with client device 10. If the user has requested content that is not free, or already paid for, then the billing component 36 either charges the users phone bill via the user's wireless carrier, or debits the user's stored credit card saved within the system billing component 36. The resulting content data package 102 is then displayed to the user on client device 10.

Social agents 34 facilitate profile matching to support a variety of dedicated applications 26, such as a dating system, a system for enabling enterprise users to find business contacts or collaborative team members, or a system for matching potential employees to employers.

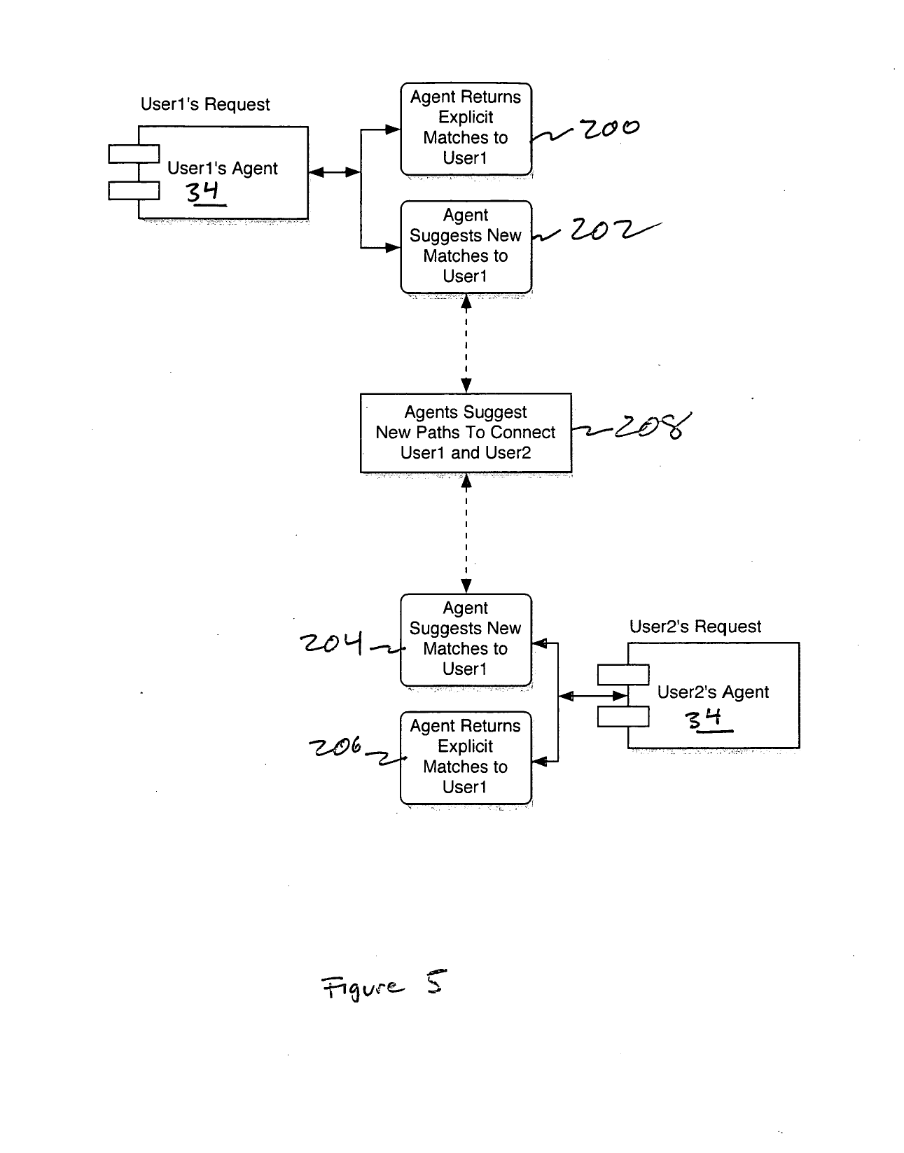

The display of personalized content in the context of the components that act on internal system data is described below. Social agents 34 are capable of reaching beyond sub-system 12a to compile data. As a result, personalized information can come from different external sources including partner database 24 and other sub-systems 12b. Social agents 34 provide a logical method of combining the various data points into a usable set of information that is unique to a specific user and provides the context in which a user receives the information. This concept is represented in FIG. 5 where the user is presented with the combined information from multiple sources and asked to rate this information based on their like, or dislike, of it. If a user likes the information then the system stores that information in primary database 38 and will remember to return more results like that one. If a user does not like the information they have been presented, then sub-system 20 stores that decision in primary database 38 and will discard any related data received from the various data sources in the future.

The operations of the components of social/mobile platform 28 are depicted in sequence in FIGS. 4a-d. As shown in FIG. 4a, user request 100 is input to user interface generation engine 30 (step 70), which first determines to request type (step 72), either API type (e.g., j2me, brew, flash, pqa or the like) or device specific template (e.g., WAP, HTML, HDML, CHTML or the like). In the event of a device specific template, a resulting device specific user interface (UI) template is created (step 74). Assets are later added to the UI template by transcoding engine 32. In the event of a device generic request, the API knows what assets are needed making a template unnecessary. Lastly, calls are made to transcoding engine 32 and social agents 34. In the event of a device generic request, the API calls to transcoding component 32 and social agents 34 (step 76). In the event of a device specific request, the UI template transcoding component 32 and social agents 34 (step 78).

The assets are the building blocks of the user interface presented on client device 10. There are static assets such as images, sound, video, and textual content. Also, there are dynamic assets, which is the content returned to the user by social agents 34 in response to user requests.

As shown in FIG. 4b, image and content transcoding engine 32 receives the API or UI call from user interface generation engine 30 (step 80). Based upon the call, image and content transcoding engine 32 requests static assets from database 20 or from the web server, which is the portion of system server 18 that handles web services (step 82). The static assets include data for dedicated application 26, if dedicated application 26 is resident on system server 18 rather than client device 10. The requested static assets are based on the client device 10. In other words, transcoding engine 32 attempts to choose assets properly formatted for the specific client device 10. While the various data sources for merged assets may contain a variety of different formats, additional transcoding is usually required. Thus, the transcoding is both on-the-fly and based upon predetermined template conditions.

After requesting the static assets, transcoding engine transcodes the static assets to the particular format (i.e., resolution, dimensions, color space/bit depth, file format, and the like) required by client device 10 (step 84). For example, transcoding engine 32 might convert a 2 megapixel photo image to a 128×128 pixel at 8 bits (less than 5 k in size) to for delivery to a specific make and model telephone, or convert a Quicktime MPEG4 video file to a 3GPT file format. Final transcoding then takes place as shown in FIG. 4c. The steps of FIG. 4b carried out by transcoding engine 32 and those of FIG. 4c carried out by social agents 34 are performed in parallel.

Social agent 34, as depicted in FIG. 4c and discussed in more detail later in this specification, is database driven and operates on three search tiers (user defined, system defined, and partner defined) as directed by the user. First, the call from either the API or UI template is received by social agent 34 (step 86). The searches are then conducted in order to yield: exact matches, historically assisted matches, and partner matches. In this tiered approach, first the user defined search is conducted to find matches based upon either the search criteria in the user request or a saved search as dictated by the user request, and further modified by the user's saved preferences (step 88). Social agent 34 then determines if other matches (system or partner may exist (step 90). Social agent 34 is continually running in the background looking for potential matches for the user, and thus gathers information from various sources that indicate other matches may exist in light of a particular user request. If not, final transcoding is conducted (step 96). If yes, the system defined matches are determined based upon recommendations from friends of the user and system generated matches (step 92). Also, the partner defined matches are determined based upon location data information and partner recommendations (step 94). Once the system defined and partner defined matches are obtained by social agent 34, the dynamic assets gathered from the three tiers are transcoded with the UI template (if applicable) and the static assets.

The social agents proceed though the search tiers (assuming the user has not opted out of system and/or partner matches) while recording user actions and placing a weighted filter on future data delivered to the user. FIG. 4c represents the path of a request for dynamic assets, the functional aspects of retrieving the data from the three possible sources (user defined, system defined, and partner defined) and passing the resulting back to transcoding component 32 to be merged with the UI interface template (step 96).

As shown in FIG. 4d, once the merged data and UI template is ready for transmission to the user, if necessary billing component 36 processes payments and settles the user's account before displaying the content on client device 10. The details of the payment and settlement process are shown in FIG. 4d. This process is standard and well known to those skilled in the art.

### Social Agents

Each social agent 34 has access to all actions performed by the host user within the system. These connections and communications are stored in the form of a weighted network. Each node represents another user. If the host user has had a lot of interaction with a specific other user, the node for this specific other user will be assigned a greater weighted value. Communications between nodes are represented as vectored objects within the weighted network. For each communication occurrence between users you will have an additional vectored object between the two user nodes. Social agents 34 retain this information in memory after initial retrieval from secondary database 40. Because of this retention of information, social agents 34 can interact effectively with only minimal interaction with secondary database 40. As a result, an extremely large social agent network can be constructed by distributing the workload from database 20 alone to social agents 34. Social agents 34 maintain state within application 26 tied to client device 10 and have access to all user functions. Social agents 34 provide the routing of assembled content through the system to render the data in a usable form back to the user's client device 10 and present their results in weighted order using bayesian algebra, among other methods, to determine the overall usefulness of a particular result.

Returning to the operation of social agents 34 as depicted in FIG. 4c, there are three search tiers. First, social agents 34 process requests 100 for personalized data by first performing an exact pattern match for existing information within primary database 38. Results of this match are weighted in order of most successful queries to least successful (i.e., there was a 100% match, a 99.6% match, an 86.4% match, etc).

Next if the user so desires, social agents 34 record all queries stored in the users history table and rate the success of past matches in order to determine if a user's specific query would be more successful by applying the criteria from past searches. This allows social agents 34 to return a higher degree of matches or a greater volume of choices by modifying certain aspects of the proginal query.

For example, the user explicitly searched for 18 year old blonde single women in Davis, Calif. and was returned appropriate matches; however, the new query (i.e., modified applying the data from the history table) returns additional matches as if the user had searched an enlarged geographic scope to include the next small town near Davis, Calif. The results of this new query are presented to the user for acceptance or rejection of the assumption that broadening the geographic area and producing more qualified leads would be acceptable. Based on the acceptance or rejection of this evolved query, social agents 34 can begin looking for better paths within the system by further modification of the original query and by the process of asking the user if this new path is acceptable or not.

In another example, a dating service user may have a strong preference for blondes, and always uses blonde hair color as a search criterion. In this situation, social agent 34 calls upon a history of user choices to offer alternative selections that meet user criteria but fall outside the specific search parameters. Social agent 34 may notice, for example, that in the past the user has also shown an interest in profiles of users who play tennis and enjoy theater. Social agent 34 then sifts through the available profiles and offers the user alternative choices based on this prior usage history: a brunette who plays tennis and enjoys the musicals of Andrew Lloyd Webber, for example. When presented with alternative choices, the user is given the ability to rate their appropriateness (“more like this,” “no more like this,” for example), which further refines the functioning of social agent 34 for that user. Thus, social agents 34 offer users alternative choices based on past user behavior that fall outside the user's specific search criteria.

Finally, data from partner database 24 (i.e., databases utilized by the user external to the system server) stored in tertiary database 42 is included to provide a third search tier. The data from the partner database 24 is made available to social agents 34. Within this further expansion of the original query a user is presented with a third layer of information based on information contained in one, or many, partner data sources 44, 46, 48.

For example, if the user listens to Brittney Spears songs from Apple Computer Inc.'s iTunes service and saves searches to find new content produced by this artist, then perhaps the user would like to have a date with a real woman who matches the physical or artistic talents of the artist he listens to. Thus, a user who often searches for one type of content on the partner service (e.g., iTunes) would be presented with new matches by the user's social agent 34 based on the search preferences from the partner service. Additionally, the user could be provided with new sources of content from the partner service that relate to the user's original query presented to social agent 34.

Social agents 34 within the system interact with each other and exchange information, as depicted in FIG. 5. If no commonality or specific search criteria are recognized, social agents 34 disengage to seek out more promising agent interactions. By comparing stored networks, social agents 34 can recognize individuals who already share contacts. It is also possible for social agents to recognize other social agents 34 with maximum connectivity within the system. Someone who is interested primarily in meeting other people can meet well-connected people through the operation of one or more social agents 34 assigned to them.

All users are provided with a default social agent. This agent retains basic information such as profile information and keywords. The default behavior of this agent is to search for users who have specified search criteria that closely matches profile characteristics of this agent's host user. Social agents 34 also store information about dates for which the host user already has a full schedule. This prevents a social agent 34 from reporting items of interest that cannot be attended due to existing schedules.

As shown in FIG. 5, in response to a request 100 from the first user on client device 10a, the first user's social agent 34 returns both explicit matches (step 200) and suggested new matches (step 202). The suggested matches may or may not be desirable to the first user. Data representative of both whether the first user wants or does not want more matches like the suggested matches is stored in the first user's preferences in primary database 38 for processing future requests in an adaptive, learning fashion. Likewise, with the second user on client device 10b, in response to a request 100 from the second user, the second user's social agent 34 returns explicit matches (step 204) and system generated recommendations (step 206). If matches (whether explicit or suggested) exist between the first and second user, social agents 34 for each user interact to suggest new paths to connect the first and second user (step 208). In this diagram user 1 and user 2 have explicitly searched for different things. Users 1's social agent 34 has modified the original query to include additional matches based on broadening the scope of the original request. User 1's social agent 34 finds enough of a similarity in user 2's query that the information is presented back to user 1. This suggestion is weighted against the results of original request and the probability of the other suggested matches being of interest to User 1.

Users may also create and utilize custom social agents to perform very specific searches. A user may create a social agent to locate other individuals who share similar specific interests. For example, a user may create a social agent to locate other individuals who listen to Zappa and who like to brew beer. Locating such individuals by word of mouth alone can be quite a daunting task. By leveraging the power of the system, a user can get excellent and exacting results with only minimal effort.

Social agents 34 can also be used to disseminate information such as web links or short stories. A user can create interest items for themselves as part of their profile descriptions. For each interest item (e.g. cooking) a user can specify multiple free form text items (e.g. recipes) or web links. Each social agent 34 will have access to the profile information for its host user. The interaction of social agents 34 will result in the exchange of free form text and web links between social agents 34, and thus users. For example, upon logging into the system, a user may see an agent report that includes a recipe for black bean tacos and several web links that were acquired from the social agent of another user. If these items are of interest to the host user, then communication channels can be established to further explore possible relationships with the other user.

Taking the example of a dedicated application 26 that is designed to deliver content to users; social agents 34 offer a degree of personalization that is currently not available. Consider a user who has subscribed to a system that sends coupons to her wireless device. Instead of being spammed with every coupon that is published on the system, social agent 34 utilizes user-defined criteria to choose coupons that are of specific interest to the user. For example, the user may specify that she wants coupons for coffee and coffee shops. After recognizing that the user always takes coupons for Peet's coffee and never Starbucks, social agent 34 always eliminates Starbucks coupons from the in-basket. When a new coffee shop opens in the user's neighborhood or a new brand of coffee is being offered in a local market, social agent 34 utilizes the user information and past usage history to decide if this coupon is appropriate to deliver to the user.

Social agents offer a further degree of functionality when social networking applications are integrated with one another. Taking the example of a content delivery system and an auction system, social agents may recognize that a specific user always chooses content that is related to Britney Spears. When Britney Spears-related merchandise appears on the auction system, the agent notifies the user and offers them the opportunity to bid on the merchandise.

While various embodiments of the present invention have been described above, it should be understood that they have been presented by way of example, and not limitation. It will be apparent to persons skilled in the relevant art that various changes in form and detail can be made therein without departing from the spirit and scope of the invention. Thus the present invention should not be limited by any of the above-described exemplary embodiments, but should be defined only in accordance with the following claims and their equivalents.

1. A method of creating a network for social interaction for a wireless client device under the control of a server and coupled to the server by a wireless carrier, comprising the steps of:
generating a search request at the client device;
transmitting the search request to the server;
generating a user interface template specially configured for display on the client device;
gathering static data for the user interface template;
gathering dynamic data responsive to the request;
merging the static data and the dynamic data into the user interface template to create a user interface; and
transmitting the user interface to the client device.

2. The method recited in claim 1, wherein the gathering step is further comprising the steps of:
determining dynamic data matching the search request based upon saved user defined preferences;
determining dynamic data matching the search request based upon social interaction applications; and
determining dynamic data matching the search request based upon information from the wireless carrier.

3. The method recited in claim 1, wherein the search request contains user defined search criteria.

4. The method recited in claim 1, wherein the search request identifies a saved user defined search.

5. The method recited in claim 1, further comprising the steps of:
prior to transmitting the user interface, collecting payment from the user.

6. A system for facilitating social interactions between a plurality of client devices on a network of a wireless carrier configured for use with a social networking application, comprising:
a central processor unit comprising:
means for generating a user interface template configured for display on a specific client device;
means for gathering assets responsive to a request from the client device; and
means for merging the user interface template and the assets;
a first data store containing data associated with the social networking application; and
a second data store containing data associated with other social networking applications.

7. The system recited in claim 6, further comprising:
a remote data store associated with the wireless carrier; and
a third data store containing data from the remote data store.
